(19) United States
(12) Patent Application Publication
(10) Pub. No.: US 2004/0105146 A1
(43) Pub. Date: Jun. 3, 2004

(54) Method, Arrangement, and Software for Monitoring and Controlling a Microscope

(75) Inventor: Frank Olschewski, Heidelberg (DE)

Correspondence Address: HOUSTON ELISEEVA, 4 MILITIA DRIVE, SUITE 4, LEXINGTON, MA, 02421, US

(73) Assignee: LEICA MICROSYSTEMS HEIDELBERG GMBH, Mannheim (DE)

(21) Appl. No.: 10/604,276

(22) Filed: Jul. 8, 2003

(30) Foreign Application Priority Data
Jul. 29, 2002 (DE) DE 102 34 404.3

(51) Int. Cl. G02B 21/00

(52) U.S. Cl. 359/368

(57) ABSTRACT

A method and an arrangement for monitoring and controlling a microscope (100, 102) are disclosed. The user is provided with a switch (41) with which he or she can initiate the method. A detector unit (19) and a computer system (23) are provided, with which the information content of at least one image can be ascertained. The computer system (23) analyzes the information content of an image and ascertains therefrom a control variable which is conveyed to at least one actuator (38) of the microscope (100, 102).

### CROSS REFERENCE TO RELATED APPLICATIONS

This application claims priority of the German patent application 102 34 404.3 which is incorporated by reference herein.

### BACKGROUND OF INVENTION

The invention concerns a method for monitoring and controlling a microscope.

The invention further concerns an arrangement for monitoring and controlling a microscope, the microscope comprising a detector unit, at least one input port for a control variable, and a computer system associated with the microscope.

### SUMMARY OF INVENTION

It is the object of the invention to create a method with which the information content during image acquisition can be kept constant.

The stated object is achieved by way of a method comprising the steps of:

a) ascertaining the information content of at least one image;

b) analyzing the information content using a specified target information content and a specified variation of the information content as the tolerance dimension;

c) determining a control variable from the analysis of the information content, using a predetermined target value for influencing the information content;

d) transferring the control variable to at least one actuator of the microscope; and e) outputting a warning signal in the event of variations of the information content beyond the tolerance dimension.

A further object of the invention is to create an arrangement for monitoring and controlling a microscope in which the information content of an image is kept very largely constant.

The stated object is achieved by way of an arrangement comprising:

a detector unit for acquiring at least one image,

at least one input port for a control variable,

a computer system associated with the microscope, wherein the information content of the at least one image can be ascertained using the detector unit and the computer system; the computer system analyzes the information content using a specified target information content and a specified variation of the information content as the tolerance dimension, and determines a control variable therefrom; from the analysis of the information content, using a predetermined target value for influencing the information content; and

at least one actuator associated with the microscope, wherein the actuator converts the control variable allocated to the actuator into a change in the information content of the image within a tolerance dimension.

It is particularly advantageous for the method if initially the information content of at least one image is ascertained. An automatic analysis of the information content is performed, using a specified target information content and a specified variation of the information content as the tolerance dimension. From the analysis, a control variable is ascertained which brings the information content of an image to a predetermined target value. The control variable is conveyed to at least one actuator of the microscope. If it is no longer possible to reach the target value, a warning signal is issued. Variations in the information content beyond the tolerance dimension mean that the predetermined target value can no longer be reached. Depending on the result of the analysis of the information content, several different control variables are determined. The computer system ascertains, from the control variable, which actuators of the microscope must be activated in order to reach the specified target value. It is further advantageous that a switch is provided with which a user initiates the automatic monitoring of the microscope.

Further advantageous embodiments of the invention are evident from the dependent claims.

### BRIEF DESCRIPTION OF DRAWINGS

The subject matter of the invention is depicted schematically in the drawings and will be described below with reference to the Figures, in which:

FIG. 1 schematically depicts a scanning microscope;

FIG. 2 is a block diagram that implements the method according to the present invention using a conventional microscope;

FIG. 3 shows an evaluation of the information content of an image in terms of the intensity, changing over time, of the detected light proceeding from a sample;

FIG. 4 shows an example of evaluation of the information content of an image via calculation of a histogram that depicts the frequency of occurrence of the intensities of the detected light proceeding from a sample at a fixed point in time;

FIG. 5 shows an example of the change over time in the histogram; and

FIG. 6 shows an example of the change over time in the histogram in which a portion of the sample disappears from the image frame.

### DETAILED DESCRIPTION

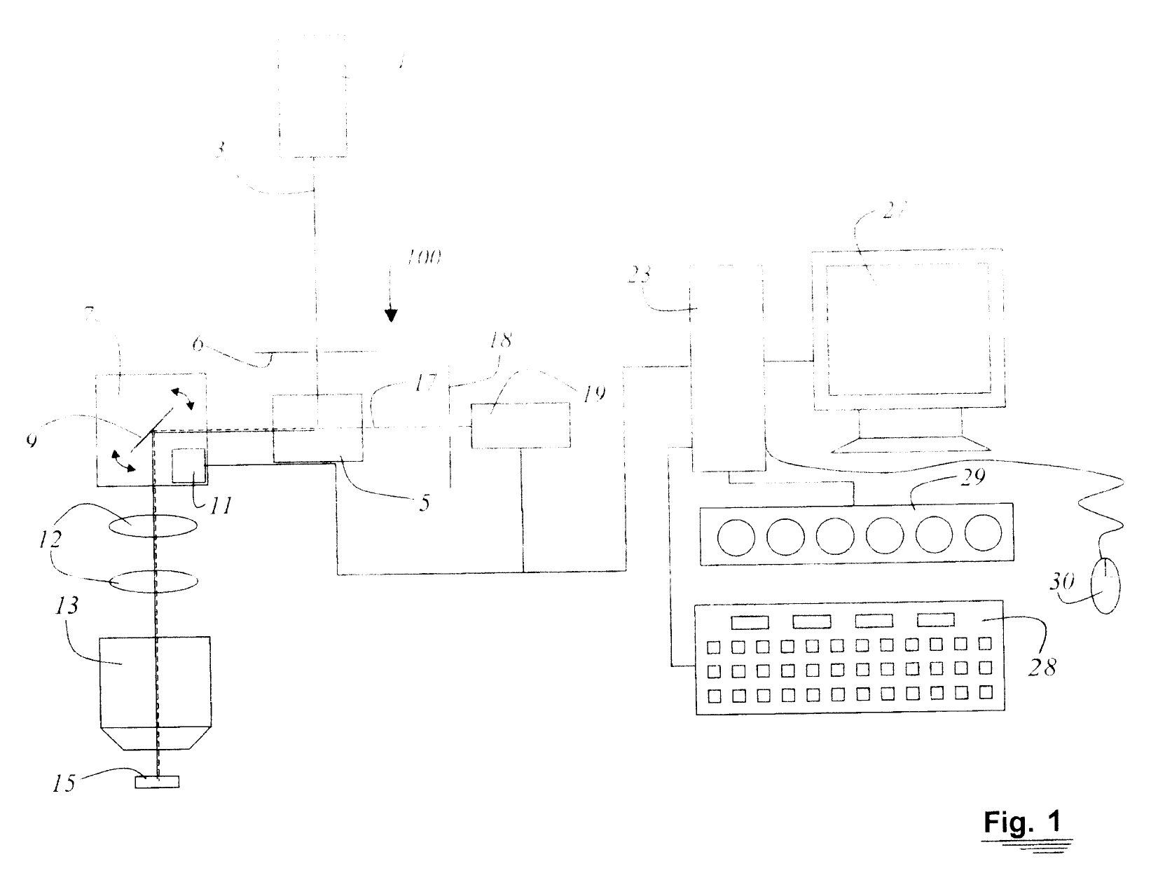

FIG. 1 schematically shows the exemplary embodiment of a confocal scanning microscope 100. This is not, however, to be construed as a limitation of the invention. It is sufficiently clear to one skilled in the art that the invention can also be implemented with a conventional microscope 100. When a conventional microscope 102 is used, the images are recorded with a camera 35 that is embodied as a video camera or CCD camera.

Illuminating light beam 3 coming from at least one illumination system 1 is directed by a beam splitter or a suitable deflection means 5 to a scanning module 7. Before illuminating light beam 3 strikes deflection means 5, it passes through an illumination pinhole 6. Scanning module 7 comprises a gimbal-mounted scanning mirror 9 that guides illuminating light beam 3 through a scanning optical system 12 and a microscope objective 13, over or through a specimen 15. In the case of non-transparent specimens 15, illuminating light beam 3 is guided over the specimen surface. With biological specimens 15 (preparations) or transparent specimens, illuminating light beam 3 can also be guided through specimen 15. For that purpose, non-luminous preparations are prepared as applicable with a suitable dye (not depicted, since established existing art). The dyes present in the specimen are excited by illuminating light beam 3 and emit light in a characteristic region of the spectrum peculiar to them. This light proceeding from specimen 15 defines a detected light beam 17. The latter travels through microscope optical system 13 and scanning optical system 12 and via scanning module 7 to deflection means 5, passes through the latter and arrives, through a detection pinhole 18, at at least one detector unit 19. Detector unit 19 can be, and is in the exemplary embodiment depicted here, embodied as a photomultiplier. It is clear to one skilled in the art that other detection components, for example diodes, diode arrays, photomultiplier arrays, CCD chips, or CMOS image sensors, can also be used. Detected light beam 17 proceeding from or defined by specimen 15 is depicted in FIG. 1 as a dashed line. In detector 19, electrical detected signals proportional to the power level of the light proceeding from specimen 15 are generated. Since, as already mentioned above, light of not only one wavelength is emitted from specimen 15, it is useful to insert in front of detector unit 19 a selection means 21 for the spectrum proceeding from the sample. The data or electrical signals generated by detector unit 19 are forwarded to a computer system 23. At least one peripheral unit 27 is associated with computer system 23. The peripheral unit can be, for example, a display on which the user receives instructions for adjusting the scanning microscope or can view the present setup and also the image data in graphical form. Also associated with computer system 23 is an input means comprising, for example, a keyboard 28, an adjusting apparatus 29 for the components of the microscope system, and a mouse 30.

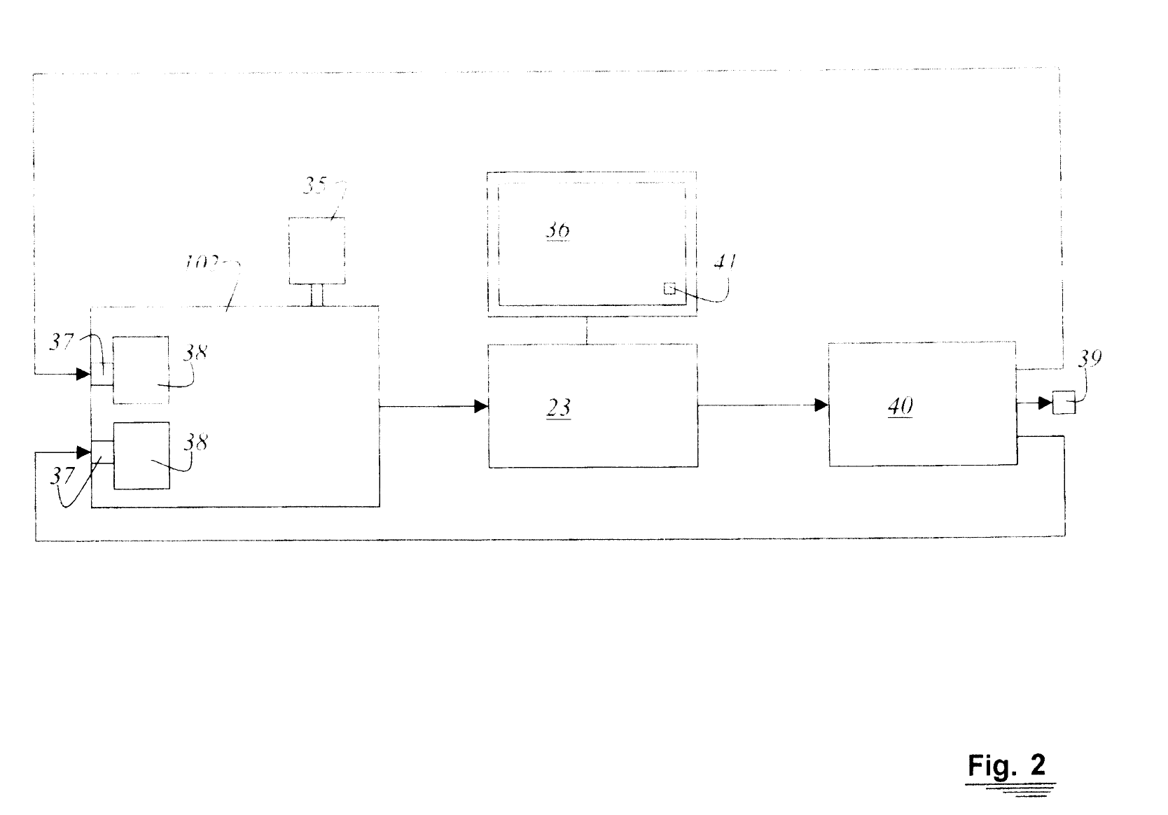

FIG. 2 is a block diagram implementing the method according to the present invention using a conventional microscope 102. Microscope 102 is depicted merely schematically, since the configuration of a microscope is sufficiently familiar to one skilled in the art. Microscope 102 possesses a camera 35 or a detector unit with which the information content coming from a sample is detected. The information contents ascertained by camera 35 or the detector unit are forwarded to computer system 23, with which a display 36 is associated. On display 36, the information contents and also the various adjustment possibilities for microscope 102 are displayed for a user. Microscope 102 possesses at least one detector unit, at least one input port 37 for a control variable. The control variable is ascertained by a sub-unit 40, associated with computer system 23, which together with the detector unit and computer system 23 ascertains the information content of at least one image. Sub-unit 40 of computer system 23 analyzes the information content using a specified target information content and a specified variation of the information content as the tolerance dimension or tolerance band. From the analysis, a control variable is determined which acts on at least one actuator 38 associated with microscope 102. The actuator or actuators 38 are adjusted in such a way that the allocated control variable(s) generate(s) a change in the information content of the image, with the goal of not departing from the tolerance dimension. A means 39 for outputting a warning signal is associated with microscope 102, providing the user with a warning signal if the variations in the information content lie outside the tolerance dimension or tolerance band. The warning signal can occur acoustically or optically. A message can also be displayed to the user on display 36, from which he or she can learn the reason for the warning. When several actuators 38 are associated with microscope 102, each of actuators 38 receives a different control variable. In this context, computer system 23 ascertains which control variable is to be modified in order to adapt the information content of an image to the specified target information content.

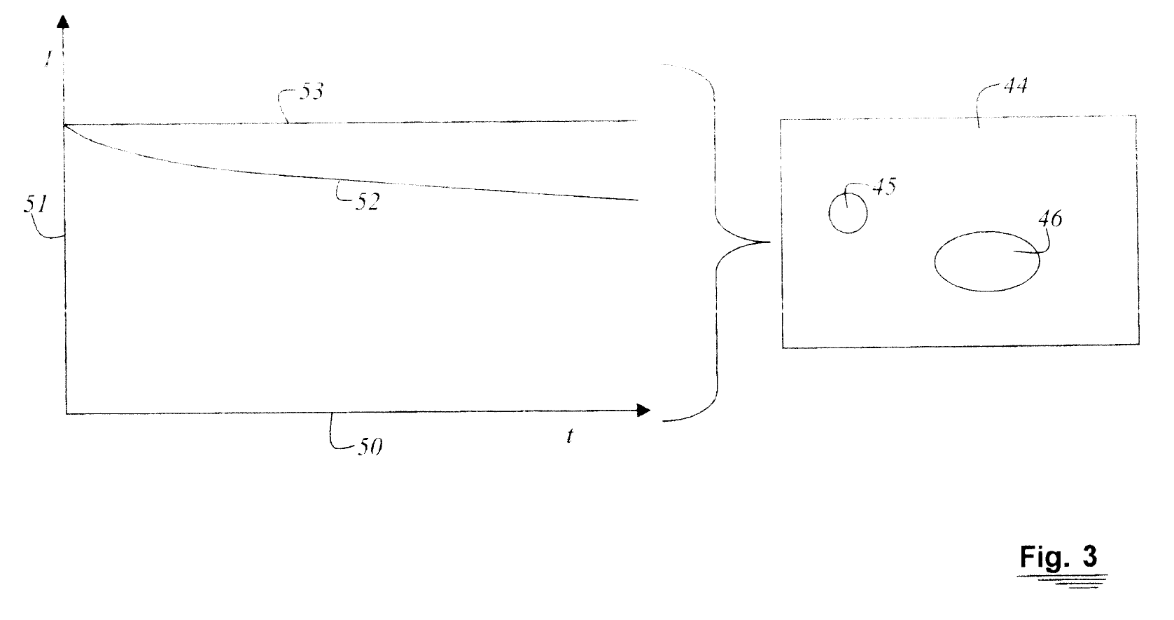

The user makes the decision to start the method according to the present invention. To do so, a switch 41 is made available to the user. The switch can be actuated, for example, via keyboard 28, adjusting apparatus 29 for the components of the microscope system or of microscope 102, or via mouse 30. Switch 41 can also be presented to the user as a click button on display 36. FIG. 3 describes an evaluation of the information content of an image in terms of the intensity, changing over time, of the detected light proceeding from a sample 44. In the sample, for example, a first and a second structure of interest 45 and 46 are provided. Alongside the schematic depiction of sample 44, intensity I of the detected light proceeding from sample 44 is plotted as a function of time t. Time t is plotted on abscissa 50. Intensity I is plotted on ordinate 51. After the actuation of switch 41, multiple images of sample 44 are gradually recorded. The average intensity is determined for each image. In FIG. 3, the measured values are depicted by a first curve 52; as a rule, intensity I decreases with time (e.g. bleaching of the sample). The target information content is determined by a second curve 53. In the present case, actuators 38 of microscope 102 must be adjusted in such a way that first curve 52 is matched to second curve 53. This can be accomplished on the one hand by increasing the intensity, and on the other hand by increasing the gain. The decision as to which control variables or actuators 38 are modified is made in the individual case by computer system 23. The properties of sample 44 being examined must also be taken into account for this purpose. With non-living, non-bleaching samples, for example, the intensity of the illuminating light can be increased. With biological samples, it is necessary to select an equilibrium between increasing the light intensity and the gain. If the light intensity is too high, damage to the sample can occur. If the gain is set too high, the noise is then also amplified.

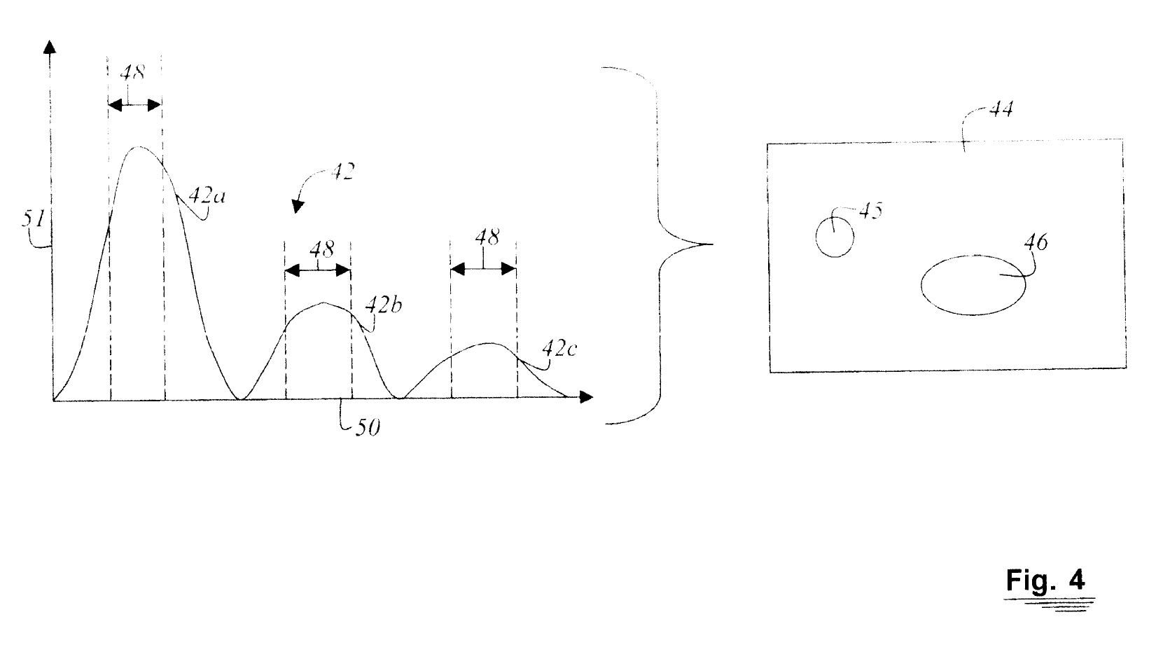

FIG. 4 shows an example of evaluation of the information content of an image using the technique of a histogram which depicts the frequency of occurrence of the intensities of the detected light proceeding from a specimen at a fixed point in time. As already mentioned above, after the user actuates the switch, a histogram 42 of the image is calculated. For color images, a color histogram is determined and depicted as applicable. The intensity of the pixel or detection region with which camera 35 acquires the images of sample 44 is plotted on abscissa 50. The normalized frequency of occurrence of the measured intensities is plotted on ordinate 51. It should be noted in this context that with the present sample 44, first structure of interest 45 shines more brightly than second structure of interest 46, and the histogram exhibits different peaks. In a subsequent step, the modes or peaks of histogram 42 are determined. This can be done using a variety of methods according to the existing art. Examples include fitting to Gaussian bell curves, the Otsu method, or entropy-based threshold determination in combination with recursive determination of the model order. In the present example, histogram 42 has a first, second, and third mode 42a, 42b, 42c. Modes 42a, 42b, 42c of histogram 42 are evaluated accordingly. Firstly the local average intensity of the individual modes 42a, 42b, 42c is determined, and from that their local intensity variance is ascertained. It is evident that each of modes 42a, 42b, 42c determines a target variable that is to be kept constant. In addition, tolerance bands 48 that the individual modes 42a, 42b, 42c must not depart from are defined in the system; the concrete derivation of tolerance bands 48 from customer specifications is not described further. Tolerance bands 48 can, for example, optionally be determined as system parameters.

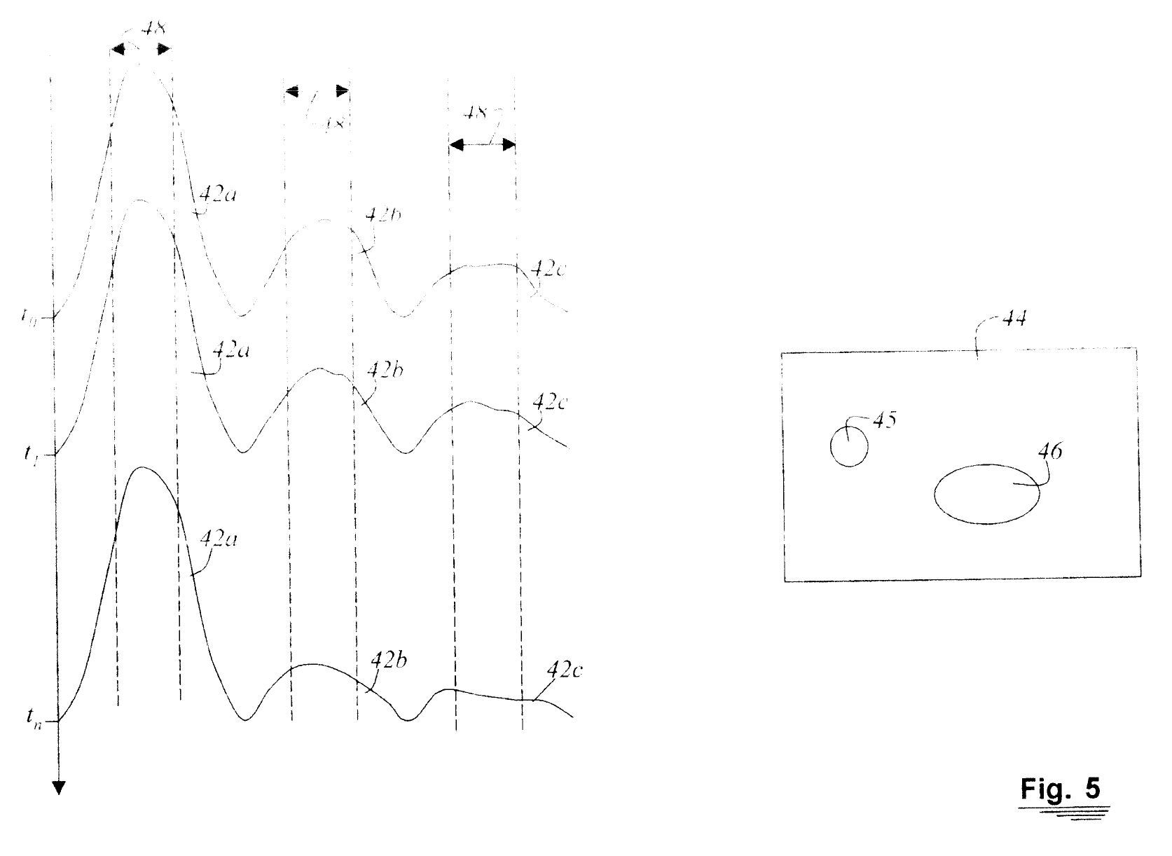

FIG. 5 shows the change over time in histogram 42. As operation proceeds, a histogram is calculated for each captured image. The modes of the histogram are also calculated. A quantity of histograms corresponding to the number of acquired images is thus obtained. The acquired histograms are compared to the histogram for the original image that was acquired at time t₀. In the present case, second 42b and third mode 42c are weaker. The maximum of second 42b and third mode 42c continues to fluctuate within tolerance band 48. If, as described in this case, second 42b and third mode 42c together move toward weaker intensities, suitable control commands must occur. In this case bleaching effects are the best explanation for the phenomenon. These can be counteracted by increasing the gain of the photomultiplier of detector unit 19. A lowering of the gain of detector unit 19 is provided for if, for example, the individual mode increase in intensity. Another possibility when the modes are decreasing is to increase the intensity of the illuminating light. In a laser scanning microscope, an AOTF (acoustooptical tunable filter) can be adjusted so that more laser light is incident onto sample 44 being examined.

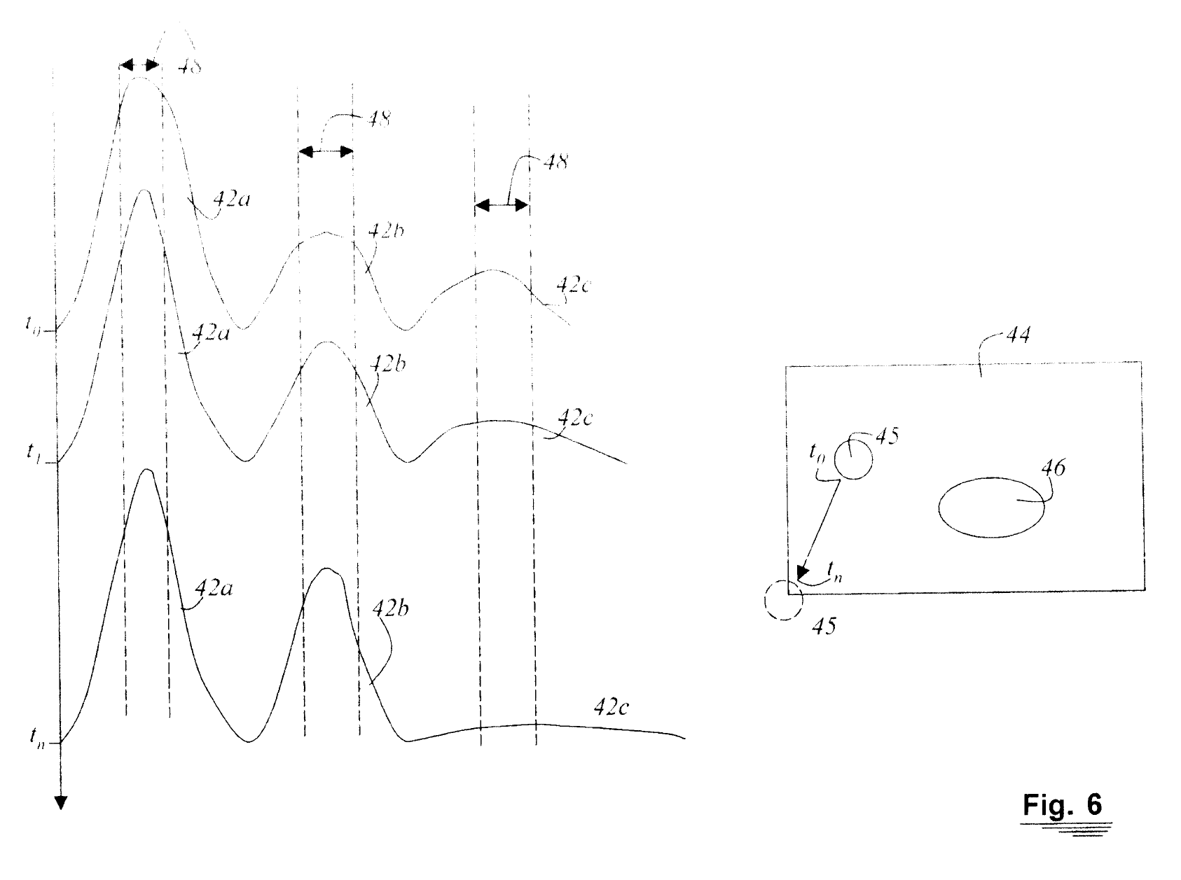

FIG. 6 describes the change over time in histogram 42 in a context in which a portion of sample 44 disappears from image frame 49 acquired by the arrangement. Third mode 42c of first structure of interest 45 is being generated. Over time (from t₀ to tₙ), first structure of interest 45 drifts out of image frame 49. First structure of interest 45 that has almost drifted out of image frame 49 is depicted with a dashed line. Here the signal of third mode 42c changes in a different way from second mode 42b. The program or method is no longer able to correct, so a warning signal is outputted to the user by means 39. The program is to be terminated. It may also happen that a tolerance band 48 is exceeded; counteracting this with the program would result merely in increased noise. Here again, it is appropriate to terminate the program.

1. A method for monitoring and controlling a microscope, comprising the following steps:
a) ascertaining the information content of at least one image;
b) analyzing the information content using a specified target information content and a specified variation of the information content as the tolerance dimension;
c) determining a control variable from the analysis of the information content, using a predetermined target value for influencing the information content;
d) transferring the control variable to at least one actuator of the microscope; and
e) outputting a warning signal in the event of variations of the information content beyond the tolerance dimension.

2. The method as defined in claim 1, wherein depending on the result of the analysis of the information content, several different control variables and actuators of the microscope are determined and activated.

3. The method as defined in claim 1, wherein the method for monitoring and controlling the microscope is initiated by a user.

4. The method as defined in claim 3, wherein the method is started by the user by means of a switch.

5. The method as defined in claim 1, wherein the microscope is embodied as a scanning microscope.

6. An arrangement for monitoring and controlling a microscope, comprising:
a detector unit for acquiring at least one image,
at least one input port for a control variable,
a computer system associated with the microscope, wherein the information content of the at least one image can be ascertained using the detector unit and the computer system; the computer system analyzes the information content using a specified target information content and a specified variation of the information content as the tolerance dimension, and determines a control variable therefrom; from the analysis of the information content, using a predetermined target value for influencing the information content; and
at least one actuator associated with the microscope, wherein the actuator converts the control variable allocated to the actuator into a change in the information content of the image within a tolerance dimension.

7. The arrangement as defined in claim 6, wherein a means for outputting a warning signal is provided, which means makes a warning signal available to the user if the variations in the information content lie outside the tolerance dimension.

8. The arrangement as defined in claim 6, wherein several actuators are associated with the microscope, each of which receives a different control variable.

9. The arrangement as defined in claim 6, wherein a switch is provided with which a user initiates the automatic monitoring of the microscope.

10. The arrangement as defined in claim 6, wherein the switch is embodied as a click button on a display associated with the computer system.

11. The arrangement as defined in claim 6, wherein the microscope is embodied as a scanning microscope.

12. Software on a data medium,
wherein a computer system connected to a microscope carries out a method comprising the steps:
a) ascertaining the information content of at least one image;
b) analyzing the information content using a specified target information content and a specified variation of the information content as the tolerance dimension;
c) determining a control variable from the analysis of the information content, using a predetermined target value for influencing the information content;
d) transferring the control variable to at least one actuator of the microscope; and
e) outputting a warning signal in the event of variations of the information content beyond the tolerance dimension.
